(19) United States
(12) Patent Application Publication
(10) Pub. No.: US 2007/0129516 A1
(43) Pub. Date: Jun. 7, 2007

(54) Copolymers comprising polyalkylene oxide groups and quaternary nitrogen atoms

(76) Inventors: Juergen Detering, Limburgerhof (DE); Thomas Pfeiffer, Bohl-Iggelheim (DE); Parmod Kakumanu Reddy, West Chester, OH (US); Xinbei None Song, Cincinnati, OH (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/579,547

(22) PCT Filed: Nov. 17, 2004
(86) PCT No.: PCT/EP04/13020

§ 371 Date: May 16, 2006

Related U.S. Application Data
(60) Provisional application No. 60/523,663, filed on Nov. 21, 2003.

(51) Int. Cl. C08F 26/06

(52) U.S. Cl. 526/260; 526/312

(57) ABSTRACT

Copolymers which comprise in copolymerized form, (A) 60 to 99% by weight of at least one monoethylenically unsaturated polyalkylene oxide monomer of the formula I
H₂C═CR¹—X—Y [symbol] —R²—O— [symbol] ₙ—R³ I in which the variables have the following meanings:
X is —CH₂— or —CO—, if Y is —O—; is —CO—, if Y is —NH—; Y is —O— or —NH—;
R¹ is hydrogen or methyl;
R² are identical or different C₂-C₆-alkylene radicals, which may be linear or branched and may be arranged blockwise or randomly;
R³ is hydrogen or C₁-C₄-alkyl; n is an integer from 3 to 50, (B) 1 to 40% by weight of at least one quaternized nitrogen-containing monoethylenically unsaturated monomer, (C) 0 to 39% by weight of anionic monoethylenically unsaturated monomers and
(D) 0 to 30% by weight of other nonionic monoethylenically unsaturated monomers and have an average molecular weight M_{w} of from 2000 to 100 000, and use of these copolymers as dispersants for clay minerals.

The present invention relates to novel copolymers which comprise, in copolymerized form,
(A) 60 to 99% by weight of at least one monoethylenically unsaturated polyalkylene oxide monomer of the formula I
   H₂C═CR¹—X—Y [symbol] —R²—O— [symbol] ₙ—R³ I
in which the variables have the following meanings:
   X is —CH₂— or —CO—, if Y is —O—; is —CO—, if Y is —NH—;
   Y is —O— or —NH—;
   R¹ is hydrogen or methyl;
   R² are identical or different C₂-C₆-alkylene radicals, which may be linear or branched and may be arranged blockwise or randomly;
   R³ is hydrogen or C₁-C₄-alkyl;
   n is an integer from 3 to 50,
(B) 1 to 40% by weight of at least one quaternized nitrogen-containing monoethylenically unsaturated monomer,
(C) 0 to 39% by weight of anionic monoethylenically unsaturated monomers and
(D) 0 to 30% by weight of other nonionic monoethylenically unsaturated monomers and have an average molecular weight M_{w} of from 2000 to 100 000.

In addition, the invention relates to the use of these copolymers as dispersants for clay minerals.

In the washing process, a distinction is drawn between primary and secondary detergency. Primary detergency is understood as meaning the actual removal of soiling from the textile ware. Secondary detergency is understood as meaning the prevention of the effects which arise as a result of the redeposition of the detached soiling from the wash liquor onto the fabric. The textiles become increasingly gray from washing operation to washing operation and this insidious graying process can scarcely be reversed. In order to protect textiles made of cotton from becoming gray, sodium salts of carboxymethylcellulose (CMC) are often added to the detergent. Polyacrylic acids and acrylic acid-maleic acid copolymers also have a graying-inhibiting action. However, the action of said polymers is not satisfactory for clay-containing soiling.

WO-A-93/22358 describes thickeners and dispersants for cosmetic preparations which are based on copolymers of at least 50% by weight of an anionic monomer, such as acrylic acid, and up to 50% by weight of an olefinically unsaturated quaternary ammonium compound. The copolymers can comprise, as further comonomer, a (meth)acrylic ester, with (meth)acrylic esters of alcohols reacted with alkylene oxide also being specified as possible comonomers. However, only copolymers which comprise stearyl methacrylate as comonomer are explicitly disclosed, and then only in amounts of at most 2.4% by weight.

WO-00/39176 discloses the use of copolymers of anionic, cationic and nonionic monomers as thickeners or rheology improvers for cosmetic and pharmaceutical preparations. Although (meth)acrylic esters of alkoxylated alcohols are listed as possible nonionic comonomers, it is pointed out that they must only be present in small amounts since otherwise the glass transition temperature of the copolymers is lowered.

In addition, WO-01/05874 describes zwitterionic polyamines which are obtained by alkoxylation of polyamines and subsequent quaternization and sulfation, and are suitable for the removal of clay-containing soiling from textiles.

Finally, DE-A-100 62 355 discloses copolymers of anionic, cationic and water-insoluble nonionic monomers for surface-treatment. Correspondingly, said nonionic monomers do not have alkylene oxide blocks, and their proportion in the copolymers is at most 16% by weight.

It is an object of the present invention to provide polymeric laundry detergent additives which are characterized by overall advantageous application properties, in particular have improved primary and secondary detergency and can be readily and stably incorporated into solid and liquid laundry detergent formulations.

We have found that this object is achieved by copolymers which comprise, in copolymerized form,
(A) 60 to 99% by weight of at least one monoethylenically unsaturated polyalkylene oxide monomer of the formula I
   H₂C═CR¹—X—Y [symbol] —R²—O— [symbol] ₙ—R³ I
in which the variables have the following meanings:
   X is —CH₂— or —CO—, if Y is —O—; is —CO—, if Y is —NH—;
   Y is —O— or —NH—;
   R¹ is hydrogen or methyl;
   R² are identical or different C₂-C₆-alkylene radicals, which may be linear or branched and may be arranged blockwise or randomly;
   R³ is hydrogen or C₁-C₄-alkyl;
   n is an integer from 3 to 50,
(B) 1 to 40% by weight of at least one quaternized nitrogen-containing monoethylenically unsaturated monomer,
(C) 0 to 39% by weight of anionic monoethylenically unsaturated monomers and
(D) 0 to 30% by weight of other nonionic monoethylenically unsaturated monomers and have an average molecular weight M_{w} of from 2000 to 100 000.

Preferred copolymers according to the invention comprise, as copolymerized component (A), monoethylenically unsaturated polyalkylene oxide monomers of the formula I in which the variables have the following meanings:
X is —CO— or —CH₂—;
Y is —O—;
R¹ is hydrogen or methyl;
R² are identical or different linear or branched C₂-C₄-alkylene radicals arranged blockwise or randomly, preferably ethylene, 1,2- or 1,3-propylene or mixtures thereof, particularly preferably ethylene;
R³ is methyl;
n is an integer from 5 to 30.

Corresponding to formula I, the monomers (A) are, for example,
reaction products of (meth)acrylic acid with polyalkylene glycols which are not terminally capped, terminally capped at one end by alkyl radicals, aminated at one end or terminally capped at one end by alkyl radicals and aminated at one end;
alkyl ethers of polyalkylene glycols which are not terminally capped or terminally capped at one end by alkyl, phenyl or alkylphenyl radicals.

Preferred monomers (A) are the (meth)acrylates and the allyl ethers, where the acrylates and primarily the methacrylates are particularly preferred.

Particularly suitable examples of the monomers (A) which may be mentioned are:
methylpolyethylene glycol (meth)acrylate and (meth)acrylamide, methylpolypropylene glycol (meth)acrylate and (meth)acrylamide, methylpolybutylene glycol (meth)acrylate and (meth)acrylamide, methylpoly(propylene oxide-co-ethylene oxide) (meth)acrylate and (meth)acrylamide, ethylpolyethylene glycol (meth)acrylate and (meth)acrylamide, ethylpolypropylene glycol (meth)acrylate and (meth)acrylamide, ethylpolybutylene glycol (meth)acrylate and (meth)acrylamide and ethylpoly(propylene oxide-co-ethylene oxide) (meth)acrylate and (meth)acrylamide, each with 3 to 50, preferably 3 to 30 and particularly preferably 5 to 30, alkylene oxide units, where methylpolyethylene glycol acrylate is preferred and methylpolyethylene glycol methacrylate is particularly preferred;
ethylene glycol allyl ethers and methylethylene glycol allyl ethers, propylene glycol allyl ethers and methylpropylene glycol allyl ethers each with 3 to 50, preferably 3 to 30 and particularly preferably 5 to 30, alkylene oxide units.

The proportion of monomers (A) in the copolymers according to the invention is 60 to 99% by weight, preferably 65 to 90% by weight.

Monomers (B) which are particularly suitable for the copolymers according to the invention are the quaternization products of 1-vinylimidazoles, of vinylpyridines, of (meth)acrylic esters with amino alcohols, in particular N,N-di(C₁-C₄-alkyl)amino-C₂-C₆-alcohols, of amino-containing (meth)acrylamides, in particular N,N-di(C₁-C₄-alkyl)-amino-C₂-C₆-alkylamides of (meth)acrylic acid, and of diallylalkylamines, in particular diallyl-C₁-C₄-alkylamines.

Very particularly suitable monomers (B) have the formula IIa to IId:

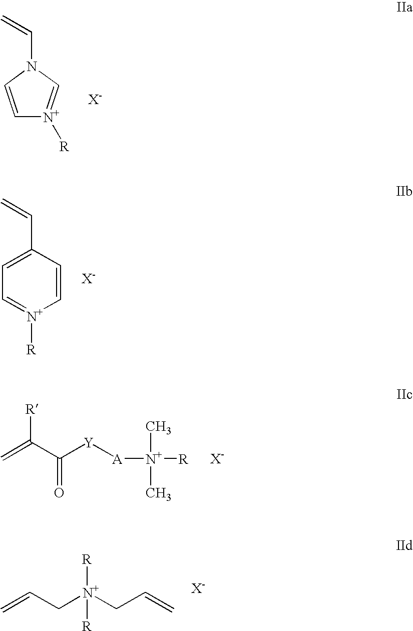

The variables in these formulae have the following meanings:
R is C₁-C₄-alkyl or benzyl, preferably methyl, ethyl or benzyl;
R¹ is hydrogen or methyl;
Y is —O— or —NH—;
A is C₁-C₆-alkylene, preferably straight-chain or branched C₂-C₄-alkylene, in particular 1,2-ethylene, 1,3- and 1,2-propylene or 1,4-butylene;
X- is halide, such as iodide and preferably chloride or bromide, C₁-C₄-alkyl sulfate, preferably methyl sulfate or ethyl sulfate, C₁-C₄-alkylsulfonate, preferably methylsulfonate or ethylsulfonate, and C₁-C₄-alkyl carbonate.

Specific examples of particularly preferred monomers (B) which may be mentioned are:
3-methyl-1-vinylimidazolium chloride, 3-methyl-1-vinylimidazolium methyl sulfate, 3-ethyl-1-vinylimidazolium ethyl sulfate, 3-ethyl-1-vinylimidazolium chloride and 3-benzyl-1-vinylimidazolium chloride;
1-methyl-4-vinylpyridinium chloride, 1-methyl-4-vinylpyridinium methyl sulfate and 1-benzyl-4-vinylpyridinium chloride;
methacrylamidopropyltrimethylammonium chloride, methacrylamidoethyltrimethylammonium chloride, trimethylammonium ethyl acrylate chloride and methyl sulfate, trimethylammonium ethyl methacrylate chloride and methyl sulfate, dimethylethyl-ammonium ethyl acrylate ethyl sulfate, dimethylethylammoniumethyl methacrylate ethyl sulfate, trimethylammonium propyl acrylate chloride and -methyl sulfate and trimethylammonium propyl methacrylate chloride and methyl sulfate;
dimethyldiallylammonium chloride and diethyldiallylammonium chloride.

Very particularly preferred monomers (B) are 3-methyl-1-vinylimidazolium chloride, 3-methyl-1-vinylimidazolium methyl sulfate, methacrylamidopropyltrimethylammonium chloride, trimethylammonium ethyl methacrylate chloride, dimethylethylammonium ethylmethacrylate ethyl sulfate and dimethyldiallylammonium chloride.

The copolymers according to the invention comprise 1 to 40% by weight, preferably 3 to 30% by weight, of monomer (B).

The weight ratio of (A) to (B) is preferably ≧2:1.

As optional components (C), the copolymers according to the invention may comprise anionic monoethylenically unsaturated monomers.

Suitable monomers (C) are, for example:
α,β-unsaturated monocarboxylic acids which preferably have 3 to 6 carbon atoms, such as acrylic acid, methacrylic acid, ethacrylic acid, crotonic acid and vinylacetic acid, preference being given to acrylic acid and methacrylic acid;
unsaturated dicarboxylic acids, which preferably have 4 to 6 carbon atoms, such as itaconic acid and maleic acid, anhydrides thereof, such as maleic anhydride;
ethylenically unsaturated sulfonic acids, such as vinylsulfonic acid, acrylamido-propanesulfonic acid, methallylsulfonic acid, methacrylsulfonic acid, m- and p-styrenesulfonic acid, (meth)acrylamidomethanesulfonic acid, (meth)acrylamidoethanesulfonic acid, (meth)acrylamidopropanesulfonic acid, 2-(meth)acrylamido-2-methylpropanesulfonic acid, 2-acrylamido-2-butanesulfonic acid, 3-methacrylamido-2-hydroxypropanesulfonic acid, methanesulfonic acid acrylate, ethanesulfonic acid acrylate, propanesulfonic acid acrylate, allyloxybenzenesulfonic acid, methallyloxybenzenesulfonic acid and 1-allyloxy-2-hydroxypropanesulfonic acid;
ethylenically unsaturated phosphonic acids, such as vinylphosphonic acid and m- and p-styrenephosphonic acid;
acidic phosphate esters of C₂-C₄-alkylene glycol mono(meth)acrylates and poly(C₂-C₄-alkylene) glycol mono(meth)acrylates, such as ethylene glycol mono(meth)acrylate, propylene glycol mono(meth)acrylate, polyethylene glycol mono(meth)acrylates and polypropylene glycol mono(meth)acrylates.

The anionic monomers (C) can be present in the form of free acids or in salt form, especially in the form of alkali metal and ammonium, in particular alkylammonium, salts, preferred salts being the sodium salts.

Preferred monomers (C) are acrylic acid, methacrylic acid, maleic acid, vinylsulfonic acid, 2-(meth)acrylamido-2-methylpropanesulfonic acid and vinylphosphonic acid, particular preference being given to acrylic acid, methacrylic acid and 2-acrylamido-2-methylpropanesulfonic acid.

The proportion of the monomers (C) in the polymers according to the invention can be up to 39% by weight, preferably from 3 to 30% by weight.

If the monomers (C) are present in the polymers according to the invention, then the weight ratio of (A) to (C) is preferably ≧2:1.

As optional component (D), the copolymers according to the invention can comprise further nonionic monoethylenically unsaturated monomers.

Suitable monomers (D) are, for example:
esters of monoethylenically unsaturated C₃-C₆-carboxylic acids, especially acrylic acid and methacrylic acid, with monohydric C₁-C₂₂-alcohols, in particular C₁-C₁₆-alcohols; and hydroxyalkyl esters of monoethylenically unsaturated C₃-C₆-carboyxlic acids, especially acrylic acid and methacrylic acid, with divalent C₂-C₄-alcohols, such as methyl (meth)acrylate, ethyl (meth)acrylate, n-butyl (meth)acrylate, sec-butyl (meth)acrylate, tert-butyl (meth)acrylate, ethylhexyl (meth)acrylate, decyl (meth)acrylate, lauryl (meth)acrylate, isobornyl (meth)acrylate, cetyl (meth)acrylate, palmityl (meth)acrylate and stearyl (meth)acrylate, hydroxyethyl (meth)acrylate, hydroxypropyl (meth)acrylate and hydroxybutyl (meth)acrylate;
amides of monoethylenically unsaturated C₃-C₆-carboxylic acids, especially acrylic acid and methacrylic acid, with C₁-C₁₂-alkylamines and di(C₁-C₄-alkyl)amines, such as N-methyl(meth)acrylamide, N,N-dimethyl(meth)acrylamide, N-ethyl-(meth)acrylamide, N-propyl(meth)acrylamide, N-tert-butyl(meth)acrylamide, N-tert-octyl(meth)acrylamide and N-undecyl(meth)acrylamide, and (meth)acrylamide;
vinyl esters of saturated C₂-C₃₀-carboxylic acids, in particular C₂-C₁₄-carboxylic acids, such as vinyl acetate, vinyl propionate, vinyl butyrate, vinyl 2-ethylhexanoate and vinyl laurate;
vinyl C₁-C₃₀-alkyl ethers, in particular vinyl C₁-C₁₈-alkyl ethers, such as vinyl methyl ether, vinyl ethyl ether, vinyl n-propyl ether, vinyl isopropyl ether, vinyl n-butyl ether, vinyl isobutyl ether, vinyl 2-ethylhexyl ether and vinyl octadecyl ether;
N-vinylamides and N-vinyllactams, such as N-vinylformamide, N-vinyl-N-methyl-formamide, N-vinylacetamide, N-vinyl-N-methylacetamide, N-vinylpyrrolidone, N-vinylpiperidone and N-vinylcaprolactam;
aliphatic and aromatic olefins, such as ethylene, propylene, C₄-C₂₄-α-olefins, in particular C₄-C₁₆-α-olefins, e.g. butylene, isobutylene, diisobutene, styrene and α-methylstyrene, and also diolefins with an active double bond, e.g. butadiene;
unsaturated nitriles, such as acrylonitrile and methacrylonitrile.

Preferred monomers (D) are methyl (meth)acrylate, ethyl (meth)acrylate, (meth)acryl-amide, vinyl acetate, vinyl propionate, vinyl methyl ether, N-vinylformamide, N-vinylpyrrolidone and N-vinylcaprolactam.

If the monomers (D) are present in the copolymers according to the invention, then their proportion may be up to 30% by weight.

The copolymers according to the invention have an average molecular weight M_{w} of from 2000 to 100 000, preferably from 3000 to 50 000 and particularly preferably from 3000 to 25 000.

The copolymers according to the invention can be prepared by free-radical polymerization of the monomers (A) and (B) and if desired (C) and/or (D). Instead of the quaternized monomers (B), it is also possible to use the corresponding tertiary amines. In this case, the quaternization is carried out after the polymerization by reacting the resulting copolymer with alkylating agents, such as alkyl halides, dialkyl sulfates and dialkyl carbonates, or benzyl halides, such as benzyl chloride. Examples of suitable alkylating agents which may be mentioned are, methyl chloride, bromide and iodide, ethyl chloride and bromide, dimethyl sulfate, diethyl sulfate, dimethyl carbonate and diethyl carbonate.

The anionic monomers (C) can be used in the polymerization either in the form of the free acids or in a form partially or completely neutralized with bases. Bases suitable for the neutralization are inorganic bases, such as alkali metal hydroxides, alkali metal carbonates and hydrogen carbonates and ammonia, and organic bases, such as amines, in particular alcohol amines. Specific examples which may be listed are: sodium hydroxide solution, potassium hydroxide solution, sodium carbonate, sodium hydrogen carbonate, ethanolamine, diethanolamine and triethanolamine.

The free-radical polymerization of the monomers can be carried out in accordance with all known methods, preference being given to the processes of solution polymerization and of emulsion polymerization.

The polymerization is advantageously carried out in water. However, it is also possible to use mixtures of water and polar organic solvents or polar organic solvents on their own as reaction medium.

Examples of suitable organic solvents are aliphatic and cycloaliphatic monohydric alcohols, such as methanol, ethanol, n-propanol, isopropanol, n-butanol, sec-butanol, tert-butanol, n-hexanol and cyclohexanol, polyhydric alcohols, e.g. glycols, such as ethylene glycol, propylene glycol and butylene glycol, and glycerol, alkyl ethers of polyhydric alcohols, e.g. methyl and ethyl ethers of said dihydric alcohols, ether alcohols, such as diethylene glycol, triethylene glycol and dipropylene glycol, cyclic ethers, such as tetrahydrofuran and dioxane, and ketones, such as acetone.

Suitable polymerization initiators are compounds which decompose thermally or photochemically (photoinitiators) to form free radicals.

Among the thermally activatable polymerization initiators, preference is given to initiators with a decomposition temperature in the range from 20 to 180° C., in particular from 50 to 90° C. Examples of particularly preferred thermal initiators are inorganic peroxo compounds, such as peroxodisulfates (ammonium and, preferably, sodium peroxodisulfate), peroxosulfates, percarbonates and hydrogen peroxide; organic peroxo compounds, such as diacetyl peroxide, di-tert-butyl peroxide, diamyl peroxide, dioctanoyl peroxide, didecanoyl peroxide, dilauroly peroxide, dibenzoyl peroxide, bis(o-tolyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate and diisopropyl peroxy-dicarbamate, azo compounds, such as 2,2′-azobisisobutyronitrile, 2,2′-azobis-(2-methylbutyronitrile), 2,2′-azobis(N,N′-dimethyleneisobutyramidine) dihydrochloride and azobis(2-amidinopropane) dihydrochloride.

Examples of suitable photoinitiators are benzophenone, acetophenone, benzoin ether, benzyl dialkyl ketones and derivatives thereof.

The polymerization initiators are used according to the requirements of the material to be polymerized, usually in amounts of from 0.01 to 15% by weight, preferably 0.5 to 5% by weight, in each case based on the monomers to be polymerized, and can be used individually or, to exploit advantageous synergistic effects, in combination with one another.

To limit the molar masses of the copolymers according to the invention, customary regulators can be added during the polymerization, e.g. mercapto compounds, such as mercaptoethanol, thioglycolic acid and sodium disulfite. Suitable amounts of regulator are generally 0.01 to 10% by weight, preferably 0.1 to 5% by weight, based on the monomers to be polymerized.

The polymerization temperature is generally 10 to 200° C., especially 50 to 100° C.

The polymerization is preferably carried out under atmospheric pressure. It can, however, also be carried out in a closed system under the autogenous pressure which develops.

The copolymers according to the invention are excellently suitable for the dispersion of clay minerals. Even the addition of very small amounts of the copolymers (e.g. 0.05 to 2% by weight, based on the clay mineral) can stabilize aqueous dispersions of clay minerals.

The copolymers according to the invention are suitable in particular as additive for solid and liquid laundry detergents. They are characterized in this connection in particular by the following advantageous application properties: They disperse particles of soiling in an excellent manner and thus prevent redeposition of the soiling onto the fabric during washing. They thus prevent graying of the textiles. In addition, they improve the primary detergency both of liquid and of solid detergents. This applies particularly for particulate soilings, but also hydrophobic, oil- and grease-containing fabric soilings are removed more easily. In particular, earth-like soilings can be removed more easily as a result of the addition of the copolymers according to the invention. In addition, they can be incorporated without problems into solid and liquid detergent formulations. In this connection, it should be emphasized that stability and homogeneity of the liquid detergent are not impaired by the copolymers according to the invention. Undesired phase formations and precipitations are not observed even upon prolonged storage.

### EXAMPLES

1. Preparation of Copolymers According to the Invention

The average molecular weights M_{w} given below were determined according to the method of size exclusion chromatography using narrow-distribution linear polymaltotriose, and maltohexose as calibration standard.

Copolymer 1

246.5 g of water were initially introduced into a 2 l polymerization vessel fitted with stirrer, reflux condenser, internal thermometer and dropping funnel and, after flushing with nitrogen, heated to 80° C. 568.8 g of a 50% strength by weight aqueous solution of methyl polyethylene glycol methacrylate (Mₙ 1000) (feed 1), 34.7 g of a 45% strength by weight aqueous solution of 3-methyl-1-vinylimidazolium methyl sulfate (feed 2), a mixture of 15 g of mercaptoethanol and 50 g of water (feed 3) and an initiator mixture of 6.0 g of 2,2′-azobis(2-amidinopropane) dihydrochloride and 80 g of water (feed 4) were then continuously added dropwise (feed 1, 2 and 3 in 3 h, feed 4 in 4 h). When the initiator addition was complete, the reaction mixture was stirred for a further 1 h at 80° C., then another initiator mixture comprising 1.5 g of 2,2′-azobis(2-amidinopropane) dihydrochloride and 20 g of water was added in one portion at this temperature. After stirring for a further two hours at 80° C., 2.75 g of 30% strength by weight hydrogen peroxide were added, and the mixture was stirred for a further 30 min at 80° C. After cooling to room temperature, the reaction mixture was filtered.

This gave a slightly yellowish, clear polymer solution with a solids content of 30.4% by weight and a pH of 4.6. The average molecular weight M_{w} of the polymer was 4600.

Copolymer 2

239.0 g of water were initially introduced into a 2 l polymerization vessel fitted with stirrer, reflux condenser, internal thermometer and dropping funnel and, after flushing with nitrogen, heated to 80° C. 51.5 g of a 50% strength by weight aqueous solution of 2-acrylamido-2-methylpropanesulfonic acid sodium salt (feed 1), 109.9 g of a 45% strength by weight aqueous solution of 3-methyl-1-vinylimidazolium methyl sulfate (feed 2), 449.6 g of a 50% strength by weight aqueous solution of methyl polyethylene glycol methacrylate (Mₙ 1000) (feed 3), a mixture of 9 g of mercaptoethanol and 50 g of water (feed 4) and an initiator mixture of 6.0 g of 2,2′-azobis(2-amidinopropane) dihydrochloride and 80 g of water (feed 5) were then continuously added dropwise (feed 1, 2, 3 and 4 in 3 h, feed 5 in 4 h). When the initiator addition was complete, the reaction mixture was stirred for a further 1 h at 80° C., then another initiator mixture comprising 1.5 g of 2,2′-azobis(2-amidinopropane) dihydrochloride and 20 g of water was added in one portion at this temperature. After stirring for a further two hours at 80° C., 1.65 g of 30% strength hydrogen peroxide were added and the mixture was stirred for a further 30 min at 80° C. After cooling to room temperature and filtering, 3.6 g of a 10% strength by weight sodium hydroxide solution were added to the filtrate.

This gave a slightly yellowish, clear polymer solution with a solids content of 30.7% by weight and a pH of 6.5. The average molecular weight M_{w} of the polymer was 6100.

Copolymer 3

243.7 g of water were initially introduced into a 2 l polymerization vessel fitted with stirrer, reflux condenser, internal thermometer and dropping funnel and, after flushing with nitrogen, heated to 80° C. A mixture of 20.7 g of methacrylic acid and 40 g of water (feed 1), 64.7 g of a 60% strength by weight aqueous solution of diallyidimethylammonium chloride (feed 2), 480.9 g of a 50% strength by weight aqueous solution of methyl polyethylene glycol methacrylate (Mₙ 1000) (feed 3), a mixture of 9 g of mercaptoethanol and 50 g of water (feed 4) and an initiator mixture of 6.0 g of 2,2′-azobis(2-amidinopropane) dihydrochloride and 80 g of water (feed 5) were continuously added dropwise (feed 1, 2, 3 and 4 in 3 h, feed 5 in 4 h). When the initiator addition was complete, the reaction mixture was stirred for a further 1 h at 80° C., another initiator mixture comprising 1.5 g of 2,2′-azobis(2-amidinopropane) dihydrochloride and 20 g of water was added in one portion at this temperature. After stirring for a further two hours at 80° C., 1.65 g of 30% strength by weight hydrogen peroxide were added and the mixture was stirred for a further 30 min at 80° C. After cooling to room temperature and filtering, 75 g of a 10% strength by weight sodium hydroxide solution were added to the filtrate.

This gave a slightly yellowish, clear polymer solution with a solids content of 28.8% by weight and a pH of 6.5. The average molecular weight M_{w} of polymer was 9800.

Copolymer 4

197.0 g of water were initially introduced into a 2 l polymerization vessel fitted with stirrer, reflux condenser, internal thermometer and dropping funnel and, after flushing with nitrogen, heated to 80° C. 417.9 g of a 50% strength by weight aqueous solution of methylpolyethylene glycol methacrylate (Mₙ 1000) (feed 1), 92.1 g of a 50% strength by weight aqueous solution of methacrylamidopropyltrimethylammonium chloride (feed 2), a mixture of 13 g of mercaptoethanol and 50 g of water (feed 3) and an initiator mixture of 5.1 g of 2,2′-azobis(2-amidinopropane) dihydrochloride and 80 g of water (feed 4) were continuously added dropwise (feed 1, 2 and 3 in 3 h, feed 4 in 4 h). When the initiator addition was complete, the reaction mixture was stirred for a further 1 h at 80° C., then another initiator mixture comprising 1.3 g of 2,2′-azobis(2-amidino-propane) dihydrochloride and 20 g of water was added in one portion at this temperature. After stirring for a further two hours at 80° C., 1.95 g of 30% strength by weight hydrogen peroxide were added and the mixture was stirred for a further 30 min at 80° C. After cooling to room temperature, the reaction mixture was filtered.

This gave a slightly yellowish, clear polymer solution with a solids content of 32.7% by weight and a pH of 5.6. The average molecular weight M_{w} of the polymer was 5000.

Copolymer 5

250.1 g of water were initially introduced into a 2 l polymerization vessel fitted with stirrer, reflux condenser, internal thermometer and dropping funnel and, after flushing with nitrogen, heated to 80° C. 51.5 g of a 50% strength by weight aqueous solution of 2-acrylamido-2-methylpropanesulfonic acid sodium salt (feed 1), 54.0 g of a 50% strength by weight aqueous solution of methacrylamidopropyltrimethylammonium chloride (feed 2), 489.8 g of a 50% strength by weight aqueous solution of methyl-polyethylene glycol methacrylate (Mₙ 1000) (feed 3), a mixture of 9 g of mercapto-ethanol and 50 g of water (feed 4) and an initiator mixture of 6.0 g of 2,2′-azobis-(2-amidinopropane) dihydrochloride and 80 g of water (feed 5) were then continuously added dropwise (feed 1, 2, 3 and 4 in 3 h, feed 5 in 4 h). When the initiator addition was complete, the mixture was stirred for a further 1 h at 80° C., then another initiator mixture comprising 1.5 g of 2,2′-azobis(2-amidinopropane) dihydrochloride and 20 g of water was added in one portion at this temperature. After stirring for a further two hours at 80° C., 1.65 g of 30% strength by weight hydrogen peroxide were added and the mixture was stirred for a further 30 min at 80° C. After cooling to room temperature and filtering, 0.8 g of a 10% strength by weight sodium hydroxide solution was added to the filtrate.

This gave a slightly yellowish, clear polymer solution with a solids content of 30.2% by weight and a pH of 6.5. The average molecular weight M_{w} of the polymer was 6500.

II. Use of Copolymers According to the Invention in Laundry Detergents

Primary and secondary detergency of the copolymers according to the invention were determined.

For the washing experiments, a solid laundry detergent formulation based on zeolite (LD 1), a solid laundry detergent formulation based on phosphate (LD 3) and a liquid laundry detergent formulation (LD 2) were used, the composition of which is given in table 1. The washing conditions are listed in table 2.

TABLE 1

| | LD 1 | LD 2 | LD 3 |
|---|---|---|---|
| Ingredients | [% by wt.] | [% by wt.] | [% by wt.] |
| Linear alkylbenzenesulfonate | 5.0 | | 20.0 |
| C₁₂-C₁₈-Alkyl sulfate | | 26.7 | |
| C₁₂-Fatty alcohol sulfate × 2 EO | | 7.1 | |
| C₁₃C₁₅-Oxo alcohol × 7 EO | 5.0 | | |
| C₁₂C₁₄-Fatty alcohol × 7 EO | | 6.0 | |
| Soap | 1.4 | | |
| Coconut fatty acid | | 5.0 | |
| Potassium hydroxide | | 1.4 | |
| Sodium citrate × 2H₂O | | 2.1 | |
| Zeolite A | 30.0 | | |
| Pentasodium triphosphate | | | 20.0 |
| Sodium carbonate | 12.0 | | 10.0 |
| Sodium metasilicate × 5H₂O | 3.6 | | 4.5 |
| Disodium tetraborate | | 2.2 | |
| Sodium perborate monohydrate | 20.0 | | |
| Tetraacetylethylenediamine | 6.0 | | |
| Methylpropylglycol | | 10 | |
| Sodium sulfate | 7.0 | | 25.0 |
| Water | ad 100 | ad 100 | ad 100 |

TABLE 2
Washing conditions

| | |
|---|---|
| Device | Launder-o-meter from. Atlas, Chicago, USA |
| Washing liquor | 250 ml |
| Washing time | 30 min at 40° C. (LD 1 and 2) |
| | 20 min at 25° C. (LD 3) |
| Detergent | 4.0 g/l (LD 1 and 2) |
| concentration | 2.0 g/l (LD 3) |
| Water hardness | 3 mmol/l Ca:Mg:HCO₃ 4:1:8 (LD 1 and 2) |
| | 1 mmol/l Ca:Mg:HCO₃ 4:1:8 (LD 3) |
| Liquor ratio | 1:12.5 |
| Washing cycles | 1 |
| Copolymer | 2.5% by wt., based on the respective LD |
| addition | |
| Test fabric | 5.0 g of cotton fabric 221 (bleached, |
| | weight per unit area 132 g/m²) |
| | 5.0 g of blended fabric 768 |
| | (65:35 polyester:cotton, bleached, |
| | weight per unit area 155 g/m²) |
| Soiled fabric | 10 g of cotton fabric 290 (twill ware, |
| | bleached, weight per unit area 193 g/m²), |
| | soiled with a 1:1:1 mixture of 3 types |
| | of clay (Na/Al silicate proportion of |
| | the soiled textile 4.53% by weight; |
| | initial reflectance 17.3%) |
| Types of clay | Niederahr red-burning clay 178/RI |
| | Hessian brown-burning manganese clay 262 |
| | Yellow-burning clay 158/G all from |
| | Jäger KG, Hilgert, Germany |

To determine the primary detergency, the degree of whiteness of the soiled fabric was measured before and after washing using a Datacolor photometer (Elrepho® 2000) by reference to the reflectance (%). The higher the reflectance value, the better the primary detergency.

The results obtained are summarized in table 3.

TABLE 3

| | Copolymer additive | Cotton 290 |
|---|---|---|
| Detergent | (2.5% by wt.) | Reflectance in % |
| Unwashed | | 17.3 |
| LD 1 | Without | 22.1 |
| LD 1 | Copolymer 1 | 24.1 |
| LD 1 | Copolymer 2 | 23.8 |
| LD 1 | Copolymer 3 | 25.6 |
| LD 1 | Copolymer 4 | 25.0 |
| LD 1 | Copolymer 5 | 24.9 |
| LD 2 | Without | 21.5 |
| LD 2 | Copolymer 1 | 23.1 |
| LD 2 | Copolymer 2 | 23.3 |
| LD 2 | Copolymer 3 | 24.1 |
| LD 2 | Copolymer 4 | 23.6 |
| LD 2 | Copolymer 5 | 23.8 |
| LD 3 | Without | 18.1 |
| LD 3 | Copolymer 1 | 20.0 |
| LD 3 | Copolymer 2 | 19.7 |
| LD 3 | Copolymer 3 | 20.4 |
| LD 3 | Copolymer 4 | 19.7 |
| LD 3 | Copolymer 5 | 19.6 |

To determine the secondary detergency, the graying of the white test fabric was measured by determining the degree of whiteness before and after washing using a Datacolor photometer (Elrepho 2000) by reference to the reflectance (%). The.greater the drop in the degree of whiteness, the greater the graying of the fabric, and vice versa.

The results obtained are summarized in table 4.

TABLE 4

| | | | Blended |
|---|---|---|---|
| | Copolymer additive | Cotton 221 | fabric 768 |
| Detergent | (2.5% by wt.) | Reflectance in % | Reflectance in % |
| Unwashed | | 83.2 | 84.9 |
| LD 1 | Without | 51.3 | 57.4 |
| LD 1 | Copolymer 1 | 55.6 | 60.0 |
| LD 1 | Copolymer 2 | 54.8 | 59.5 |
| LD 1 | Copolymer 3 | 56.78 | 60.8 |
| LD 1 | Copolymer 4 | 55.9 | 59.4 |
| LD 1 | Copolymer 5 | 54.5 | 58.9 |
| LD 2 | Without | 42.6 | 54.6 |
| LD 2 | Copolymer 1 | 48.3 | 58.3 |
| LD 2 | Copolymer 2 | 47.5 | 57.0 |
| LD 2 | Copolymer 3 | 49.4 | 58.3 |
| LD 2 | Copolymer 4 | 48.4 | 57.7 |
| LD 2 | Copolymer 5 | 47.4 | 57.7 |
| LD 3 | Without | 52.9 | 54.6 |
| LD 3 | Copolymer 1 | 59.2 | 59.7 |
| LD 3 | Copolymer 2 | 58.2 | 59.1 |
| LD 3 | Copolymer 3 | 60.3 | 58.9 |
| LD 3 | Copolymer 4 | 58.0 | 55.7 |
| LD 3 | Copolymer 5 | 59.0 | 59.0 |

1. A copolymer which comprises, in copolymerized form,
(A) 60 to 99% by weight of at least one monoethylenically unsaturated polyalkylene oxide monomer of the formula I
H₂C═CR¹—X—Y—(—R²—O—)ₙ—R³ I
in which the variables have the following meanings:
X is —CH₂— or —CO—, if Y is —O—; is —CO—, if Y is —NH—;
Y is —O— or —NH—;
R¹ is hydrogen or methyl;
R² are identical or different C₂-C₆-alkylene radicals, which may be linear or branched and may be arranged blockwise or randomly;
R³ is hydrogen or C₁-C₄-alkyl;
n is an integer from 3 to 50,
(B) 1 to 40% by weight of at least one quaternized nitrogen-containing monoethylenically unsaturated monomer,
(C) 0 to 39% by weight of anionic monoethylenically unsaturated monomers and
(D) 0 to 30% by weight of other nonionic monoethylenically unsaturated monomers
and have an average molecular weight M_{w} of from 2000 to 100 000.

2. The copolymer according to claim 1, which comprises, in copolyrnerized form, as monomer (A), at least one monomer of the formula I in which the variables have the following meanings:
X is —CO— or —CH₂—;
Y is —O—;
R¹ is hydrogen or methyl;
R² is ethylene, propylene or mixtures thereof;
R³ is methyl;
n is an integer from 5 to 30.

3. The copolymer according to claim 1, which comprises, in copolymerized form, as monomer (B), at least one of the monomers of the formula IIa to IId 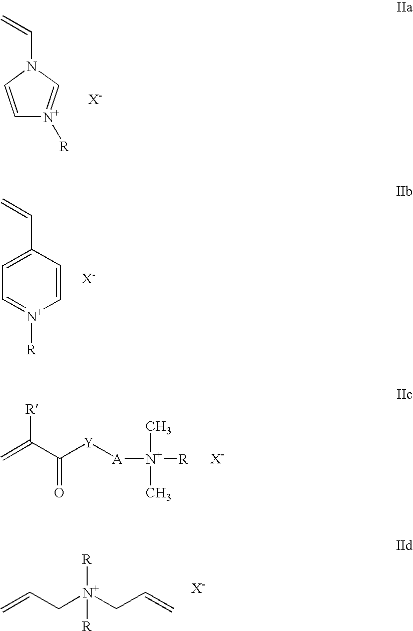
in which the variables have the following meanings:
R is C₁-C₄-alkyl or benzyl;
R¹ is hydrogen or methyl;
Y is —O— or —NH—;
A is C₁-C₆-alkylene;
X- is halide, C₁-C₄-alkyl sulfate, C₁-C₄-alkylsulfonate and C₁-C₄-alkyl carbonate.

4. The copolymer according to claim 1, which comprises, in copolymerized form, 60 to 98% by weight of monomer (A), 1 to 39% by weight of monomer (B) and 1 to 39% by weight of monomer (C).

5. The copolymer according to claim 1, in which the weight ratio of (A) to (B) is ≧2:1 and for the case where the copolymers comprise a monomer (C) in copolymerized form, the weight ratio of (A) to (C) is also ≧2:1.

6. The method of using copolymers according to claim 1 as dispersants for clay minerals.
